(19) United States
(12) Patent Application Publication
(10) Pub. No.: US 2006/0132098 A1
(43) Pub. Date: Jun. 22, 2006

(54) Smart battery simulating system

(76) Inventors: Min-Hsiung Lin, Tainan Hsien (TW); Wen-Tang Lin, Taichung City (TW)

Correspondence Address: Law Office of Kenneth C. Brooks, P.O. Box 10417, Austin, TX, 78766-1417, US

(21) Appl. No.: 11/018,734

(22) Filed: Dec. 21, 2004

(51) Int. Cl. H02J 7/04

(52) U.S. Cl. 320/150

(57) ABSTRACT

A smart battery simulating system, which is applied to test response of an embedded controller of a portable electronic device to different battery conditions, includes a smart battery simulator and an application program. The smart battery simulator is coupled to the embedded controller of the portable electronic device and a computing device, and is operable so as to receive an input signal representative of battery-specific test characteristics from the computing device, and so as to generate an output signal that corresponds to the input signal and that is to be provided to the embedded controller of the portable electronic device. The application program is installed in and is executed by the computing device so as to configure the computing device to provide the input signal to the smart battery simulator when the computing device executes the application program.

### BACKGROUND OF THE INVENTION

1. Field of the Invention

The invention relates to a battery simulating system, more particularly to a smart battery simulating system adapted for testing response of an embedded controller of a portable electronic device to different battery conditions.

2. Description of the Related Art

Smart batteries are used in many existing portable electronic devices. Typically, the smart battery provides the portable electronic device with its residual capacity information. The portable electronic device includes an embedded controller that receives the residual capacity information of the battery. Thereafter, the portable electronic device performs power management in accordance with the residual capacity information received by the embedded controller of the portable electronic device.

It is therefore important to test whether the embedded controller of the portable electronic device is functioning properly. A conventional method of testing the embedded controller of the portable electronic device includes the steps of charging and discharging of the smart battery, and operating the portable electronic device to determine the response of the embedded controller of the portable electronic.

However, since the charging/discharging operation of the smart battery is a relatively slow process, this approach for testing the embedded controller of the portable electronic device requires a considerable amount of time to complete.

### SUMMARY OF THE INVENTION

Therefore, the object of the present invention is to provide a smart battery simulating system that can be applied to shorten the time required to complete testing of an embedded controller of a portable electronic device.

According to the present invention, a smart battery simulating system, which is applied to test response of an embedded controller of a portable electronic device to different battery conditions, comprises a smart battery simulator and an application program. The smart battery simulator is coupled to the embedded controller of the portable electronic device and a computing device, and is operable so as to receive an input signal representative of battery-specific test characteristics from the computing device, and so as to generate an output signal that corresponds to the input signal and that is to be provided to the embedded controller of the portable electronic device. The application program is installed in and is executed by the computing device so as to configure the computing device to provide the input signal to the smart battery simulator when the computing device executes the application program.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of the preferred embodiment of a smart battery simulating system according to the present invention; and

FIG. 2 is a schematic block diagram illustrating the preferred embodiment in a state of use.

### DETAILED DESCRIPTION OF THE PREFERRED EMBODIMENT

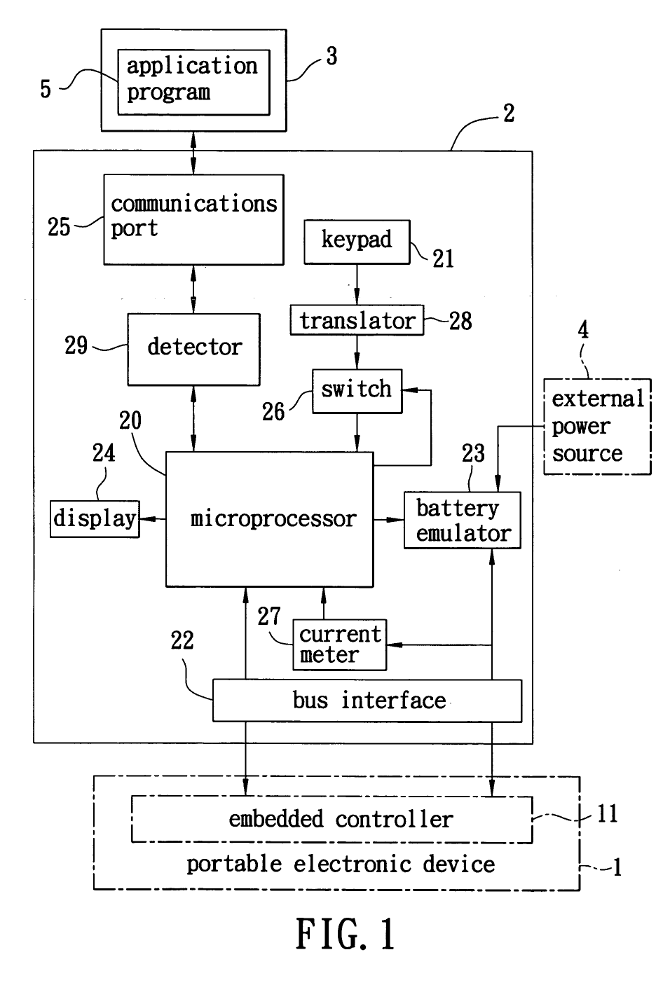

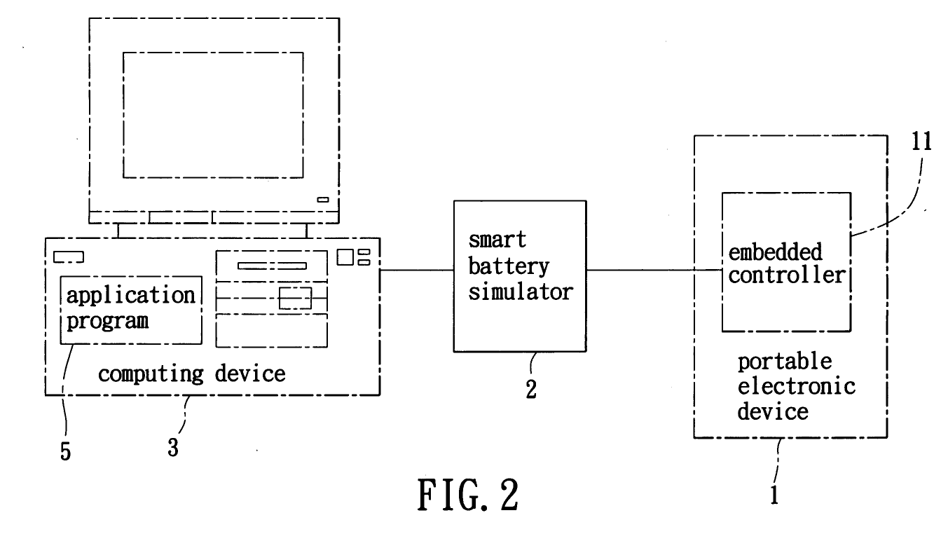

Referring to FIGS. 1 and 2, the preferred embodiment of a smart battery simulating system according to this invention is shown to include a smart battery simulator 2 and an application program 5.

The smart battery simulating system of this embodiment is applied to test response of an embedded controller 11 of a portable electronic device 1 to different battery conditions, in a manner that will be described hereinafter.

It is noted that the portable electronic device 1 may be a notebook computer, a mobile phone, or a personal digital assistant (PDA).

The smart battery simulator 2 includes a microprocessor 20, a user input unit, a communications port 25, a battery emulator 23, a current meter 27, a bus interface 22, and a display 24.

The microprocessor 20 of the smart battery simulator 2 is coupled to the embedded controller 11 of the portable electronic device 1 and a computing device 3. In this embodiment, the microprocessor 20 of the smart battery simulator 2 is operable so as to receive an input signal representative of battery-specific test characteristics from the computing device 3, so as to generate an output signal that corresponds to the input signal and that is to be provided to the embedded controller 11 of the portable electronic device 1, and so as to monitor the response of the embedded controller 11 of the portable electronic device 1 to the input signal.

The application program 5 is installed in and is executed by the computing device 3. In this embodiment, the application program configures the computing device 3 to provide the input signal to the microprocessor 20 of the smart battery simulator 2 when the computing device 3 executes the application program 5. It is noted that the application program 5 further configures the computing device 3 to analyze the response of the embedded controller 11 of the portable electronic device 1 to the input signal as monitored by the microprocessor 20 of the smart battery simulator 2 when the computing device 3 executes the application program 5.

It is noted that the battery-specific test characteristics include a battery voltage, charging control data, and temperature control data.

The user input unit is coupled to the microprocessor 20, and is operable so as to provide the input signal to the microprocessor 20. In particular, the user input unit includes a keypad 21 and a translator 28. The keypad 21 is coupled to the microprocessor 20, and is operable so as to input the battery-specific test characteristics. The translator 28 is coupled between the keypad 21 and the microprocessor 20, and is operable so as to translate the battery-specific test characteristics inputted through the keypad 21 into the input signal that is provided to the microprocessor 20.

The communications port 25, preferably a RS-232 serial interface, is coupled to the microprocessor 20 and the computing device 3. The microprocessor 20 receives the input signal from the computing device 3 through the communications port 25.

The detector 29 is coupled between the microprocessor 20 and the communications port 25, and is operable so as to detect receipt of the input signal from the computing device 3.

The switch 26 is coupled between the microprocessor 20 and the translator 28 of the user input unit. In this embodiment, the switch 26 is operable in an on state, where the switch 26 connects the microprocessor 20 to the translator 28 when the detector 29 does not detect the receipt of the input signal from the computing device 3, and in an off state, where the switch 26 disconnects the microprocessor 20 from the translator 28 of the user input unit when the detector 29 detects receipt of the input signal from the computing device 3. The microprocessor 20 is further operable so as to control operation of the switch 26 between the on and off states.

The battery emulator 23 is coupled to the microprocessor 20 and the embedded controller 11 of the portable electronic device 1, and an external power source 4. In this embodiment, the battery emulator 23 is operable in a discharging mode, where the battery emulator 23 generates a discharge current that is supplied to the embedded controller 11 of the portable electronic device 1, and in a charging mode, where the battery emulator 23 draws a charge current from the embedded controller 11 of the portable electronic device 1.

It is noted that the battery-specific test characteristics further include battery emulator control data. The microprocessor 20 is further operable so as to control the operation of the battery emulator 23 between the discharging and charging modes in accordance with the battery emulator control data. As such, the duration at which the battery emulator 23 operates in the charging or discharging mode is under the control of test personnel (not shown).

The current meter 27 is coupled between the microprocessor 20 and the battery emulator 23. In this embodiment, the current meter 27 is operable so as to measure the discharge current supplied by the battery emulator 23 to the embedded controller 11 of the portable electronic device 1 when the battery emulator 23 is operated in the discharging mode.

The microprocessor 20 is further operable so as to adjust the discharge current supplied by the battery emulator 23 to the embedded controller 11 of the portable electronic device 1 in accordance with the discharge current measured by the current meter 27.

It is noted that the embedded controller 11 of the portable electronic device 1 likewise measures the discharge current supplied by the battery emulator 23 to the embedded controller 11 of the portable electronic device 1. As such, when the current meter 27 is inoperative, the microprocessor 20 is able to adjust the discharge current supplied by the battery emulator 23 to the embedded controller 11 of the portable electronic device 1 in accordance with the discharge current measured by the embedded controller 11 of the portable electronic device 1.

In an alternative embodiment, the microprocessor 20 is further operable so as to compute the average value of the discharge current measured by the current meter 27 and the discharge current measured by the embedded controller 11 of the portable electronic device 1. The microprocessor 20 then adjusts the discharge current supplied by the battery emulator 23 to the embedded controller 11 of the portable electronic device 1 in accordance with the average discharge current computed thereby.

The bus interface 22 is coupled to the microprocessor 20 and the embedded controller 11 of the portable electronic device 1. The microprocessor 20 provides the output signal to and receives the discharge current measured by the embedded controller 11 of the portable electronic device 1 through the bus interface 22. The battery emulator 23 supplies the discharge current to and draws the charge current from the embedded controller 11 of the portable electronic device 1 through the bus interface 22. Preferably, the bus interface 22 is a system management (SM) bus.

The display 24 of the smart battery simulator is coupled to and controlled by the microprocessor 20 so as to show the battery-specific test characteristics thereon. Preferably, the display 24 is a seven-segment display.

In use, to test whether the embedded controller 11 of the portable electronic device 1 is functioning properly, the smart battery simulating system of this embodiment may be operated in a manual or automatic test mode. In the manual test mode, the user input unit of the smart battery simulator 2 is operated to provide the input signal to the microprocessor 20. Thereafter, the portable electronic device 1 is operated to determine the response of the embedded controller 11 of the portable electronic device 1 to the input signal. In the automatic test mode, the computing device 3 is operated to execute the application program 5 such that the application program 5 configures the computing device 3 to provide the input signal to the microprocessor 20 of the smart battery simulator 2 through the communications port 25, and to analyze the response of the embedded controller 11 of the portable electronic device 1 to the input signal as monitored by the microprocessor 20. It is noted that in the manual test mode, the computing device 3 may be operated to execute the application program 5 such that the application program 5 configures the computing device 3 to provide the input signal to the microprocessor 20 of the smart battery simulator 2 through the communications port 25. Moreover, in the automatic test mode, the computing device 3 may be operated to execute the application program 5 such that the computing device 3 performs automatic repeated testing.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A smart battery simulating system adapted for testing response of an embedded controller of a portable electronic device to different battery conditions, said smart battery simulating system comprising:
a smart battery simulator adapted to be coupled to the embedded controller of the portable electronic device and a computing device, said smart battery simulator being operable so as to receive an input signal representative of battery-specific test characteristics from the computing device, and so as to generate an output signal that corresponds to the input signal and that is to be provided to the embedded controller of the portable electronic device; and
an application program adapted to be installed in and to be executed by the computing device, for configuring the computing device to provide the input signal to said smart battery simulator when the computing device executes said application program.

2. The smart battery simulating system as claimed in claim 1, wherein said smart battery simulator includes a communications port adapted to be coupled to the computing device so as to receive the input signal therefrom.

3. The smart battery simulating system as claimed in claim 2, wherein said communications port is a RS-232 serial interface.

4. The smart battery simulating system as claimed in claim 1, wherein the battery-specific test characteristics include at least one of a battery voltage, charging control data, and temperature control data.

5. The smart battery simulating system as claimed in claim 1, wherein said smart battery simulator is further operable so as to monitor response of the embedded controller of the portable electronic device to the input signal.
